(19) United States
(12) Patent Application Publication
(10) Pub. No.: US 2014/0258921 A1
(43) Pub. Date: Sep. 11, 2014

(54) SYSTEM AND METHOD FOR ERGONOMIC PLACEMENT OF AN OBJECT OR CURSOR ON A COMPUTER DISPLAY

(71) Applicant: COREL CORPORATION, Ottawa (CA)

(72) Inventor: Claude Peloquin, Gatineau (CA)

(73) Assignee: Corel Corporation, Ottawa (CA)

(21) Appl. No.: 13/793,761

(22) Filed: Mar. 11, 2013

(51) Int. Cl. G06F 3/0485

(52) U.S. Cl. CPC G06F 3/04855
USPC 715/786

(57) ABSTRACT

A method includes the steps of: providing a computer readable code configured to run on a local computer and configured to perform a process keep a reference point of an item in a substantially fixed position on a computer display while the item is being edited; running the computer readable code on the local computer; detecting by computer a user edit; recording by computer a position of the reference point of the item on the computer display and a value of a scroll bar; calculating by computer a new point of the reference point of the item and a new value of the scroll bar such that following the user edit, the reference of the item remains at the substantially fixed position on the computer display; and redrawing the item near the substantially fixed position on the computer display. A system to perform the method is also described.

### FIELD OF THE INVENTION

The invention relates to placing items on a computer display and more particularly to a system and method for ergonomic placement of an object or cursor on a computer display.

### BACKGROUND OF THE INVENTION

Computer programs display objects on a computer display. The computer program determines where the objects will be displayed on the screen. For any given screen resolution and/or “zoom” setting, some of the objects may be “off-screen” as represented, for example, by a scroll bar. Also, there is usually a computer cursor located somewhere on the computer display where a user is expected to edit, add, or deleted objects. Or, the cursor may be “off screen” in an area which can be found by moving one or more of the scroll bars (e.g. a vertical and/or horizontal scroll bar). The convention for editing, especially where the objects are characters of text as used in a word processing application, is for the computer program to move the cursor down on a displayed screen as objects (e.g. characters) are entered, and then to begin scrolling to a new screen (e.g. another page).

The cursor at an editing point also moves by convention when a property that affects the size of one or more objects is changed. For example, if the font size of one object in a list of objects is increased, if still on one screen without a scroll bar, the convention is to maintain an object near the top of the screen in view, and to move down objects below that object, including moving down the present cursor position. That is, the top of the top object is anchored at the top edge of the display screen and there is downward movement of one or more objects and the cursor on the screen. A user editing at the cursor moves their head and or eyes accordingly to follow the cursor.

Ergonomics generally refers to physical accommodation to reduce stress, fatigue, and increase productivity by making a person more comfortable and thus more efficient at a task at hand. The head and eye movements associated with prior art cursor movement related to changes to objects on a computer display are not ergonomic.

### SUMMARY OF THE INVENTION

There is a need for a more ergonomic system and method for ergonomic placement of an object and cursor on a computer display.

According to one aspect, the invention features a method which includes the steps of: providing a computer readable non-transitory storage medium including a computer readable code configured to run on a local computer and configured to perform a process keep a reference point of an item in a substantially fixed position on a computer display while the item is being edited; running the computer readable code on the local computer; detecting by computer a user edit; recording by computer a position of the reference point of the item on the computer display and a value of a scroll bar; calculating by computer a new point of the reference point of the item and a new value of the scroll bar such that following the user edit, the reference point of the item remains at the substantially fixed position on the computer display; and redrawing the item near the substantially fixed position on the computer display.

In one embodiment, the user edit includes an edit of a property of one or more characters of text.

In another embodiment, the property includes a font size.

In yet another embodiment, the property includes a font type.

In yet another embodiment, the user edit includes an edit of a graphic object.

In yet another embodiment, the item is an item of a list of items and wherein the user edit includes a user edit of the list of items.

In yet another embodiment, the step of calculating by computer a new point of the reference point includes the item edited for increased height on the screen and the scroll bar causing an item above the item to move at least in part off of a presently displayed redrawn screen view.

In yet another embodiment, the step of calculating by computer a new point of the reference point includes the item edited for decreased height on the screen and the scroll bar causing at least one item above the item and at least one item below the item to move closer to the item.

In yet another embodiment, the step of calculating by computer a new point of the reference point includes calculating a new point in two or more dimensions.

In yet another embodiment, the step of calculating by computer a new point of the reference point includes calculating a new point in a time dimension.

In yet another embodiment, the computer display includes a 2D display screen or a 3D display system.

According to another aspect, the invention features a method which includes the steps of: providing a computer readable non-transitory storage medium including a computer readable code configured to run on a local computer and configured to perform a process to keep a cursor entry point near an item on a computer display while the item is being edited; running the computer readable code on the local computer; detecting by computer a user edit; recording by computer a position of the cursor entry point on the computer display and a value of a scroll bar; calculating by computer a new cursor entry point and a new value of the scroll bar such that following the user edit, such that the cursor entry point remains near the item on the computer display; and redrawing the cursor entry point near the item on the computer display.

In one embodiment, the computer readable code further includes a word processing program and the item includes a character of text.

In another embodiment, the user edit includes a change of a font property.

In yet another embodiment, the change includes a change of font size.

In yet another embodiment, the change includes a change of font type.

According to yet another aspect, the invention features a system which includes a computer readable code configured to run on a local computer including a user entry device and a core program configured to perform a process to keep a reference point of an item in a substantially fixed position on a computer display while the item is being edited. The core program is configured to run the computer readable code on the local computer; to detect by computer a user edit; to record by computer a position of the reference point of the item on the computer display and a value of a scroll bar; to calculate by computer a new point of the reference point of the item and a new value of the scroll bar such that following the user edit, the reference of the item remains at the substantially fixed position on the computer display; and to redraw the item near the substantially fixed position on the computer display.

In one embodiment, the core program includes a computer graphics program and the item includes an item of a list of items.

In another embodiment, the core program includes a word processing program and the item includes a character or a word.

In yet another embodiment, the user entry device includes a computer mouse.

The foregoing and other objects, aspects, features, and advantages of the invention will become more apparent from the following description and from the claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1A shows a diagram illustrating two different ways to modify a computer displayed screen when an object in a list is made larger;

FIG. 1B shows a diagram illustrating two different ways to modify a computer displayed screen when an object in a list is made smaller;

FIG. 1C shows a diagram illustrating two different ways to modify a computer displayed screen when an object in a list is made larger and the list includes objects which are “off-screen”;

FIG. 2A shows an exemplary list where a user is currently editing the third item of a list;

FIG. 2B shows a representation of the list of FIG. 2A which illustrates an intermediate process calculation;

FIG. 2C shows how the third item can be maintained in substantially the same displayed position following a user edit;

FIG. 3 shows a computer display screen of a word processing document page that fits on a single displayed screen;

FIG. 4A and FIG. 4B shows how the word processing document is displayed according to convention following a change in font size from an 11 font size to a 44 font size;

FIG. 5 shows a more ergonomic approach which maintains an editing position of FIG. 3 following a similar font size change;

FIG. 6 shows one exemplary system suitable for performing the process described herein;

FIG. 7 shows a block diagram of one exemplary process for ergonomic display of objects after the size of an object is changed; and

FIG. 8 shows a block diagram of one exemplary process for ergonomic display of a cursor after the size of an object is changed.

### DETAILED DESCRIPTION

When entering text in a computer program, it is convention that the cursor, or point of entry of each new character of text, moves down the screen. Moreover, when the text extends beyond more than the size of one display screen (for any given screen view, font size, etc.), there usually appears a scroll bar. Convention is to expand the text or items above the present working position on the screen and typically the scroll bar moves “down” as the older text moves up and off the screen.

Some computer programs, such as for example, CorelDRAW™ available from the Corel Corporation of Ottawa, Canada, create lists of items, such as lists of stylized font choices. A user can edit an entry on the list and simultaneously view substantially in real-time the same characters of text in a variety of stylized fonts. Ultimately, the user can pick one version and place it in a drawing. The problem is that while focusing the user's attention on the entry being edited, the position of the entry being edited moves up or down the list as font sizes are changed and/or more or less lines of characters of text are typed or deleted. For example, if a user increases the font of an item being edited, the list item moves down, since it needs more height on the screen. The user's eyes need to move down accordingly. Similarly, if the user reduces the font size, the item moves up on the screen and the user's eyes need to follow, now looking higher on the screen.

It was realized that movement of the cursor entry point during text entry was distracting and fatiguing to the user. A solution to the problem is to abandon the convention for entry at a cursor where the cursor moves up or down a screen based on what came before (e.g. list items above a list item being edited). Contrary to the cursor operation of the prior art, the solution is to maintain the location of an item being edited on a screen at substantially a fixed position on the screen during editing. The relative position of then entry point cursor can be held in about the same position (typically at or near a vertical position or an entry line) regardless of whether the text before and after fits on the screen (no scroll bar) or not (with a scroll bar showing where off screen content lies). The new display list system and method is first described for application to a list of items. However, the technique is believed to be generally applicable any form of entry at a cursor entry point, and particularly to any form of text entry at a screen cursor entry point.

Item in a List Remains Stationary:

The solution causes a reference point of an item in a list being edited to remain substantially stationary in a substantially fixed location on the computer display during editing. Because the user's eyes move less while editing an item near a fixed location on the screen, there is less user fatigue and the user is less distracted from the editing task at hand.

In the three examples which follow, stylized items are listed in a box. Only one of the items is edited a time. However the property being edited is applied to all of the items in the list. For example, a user might want to see the effect of increasing or decreasing a font size. The font size of all of the items of the list changes along with the font size of the item in view being edited.

### Example 1

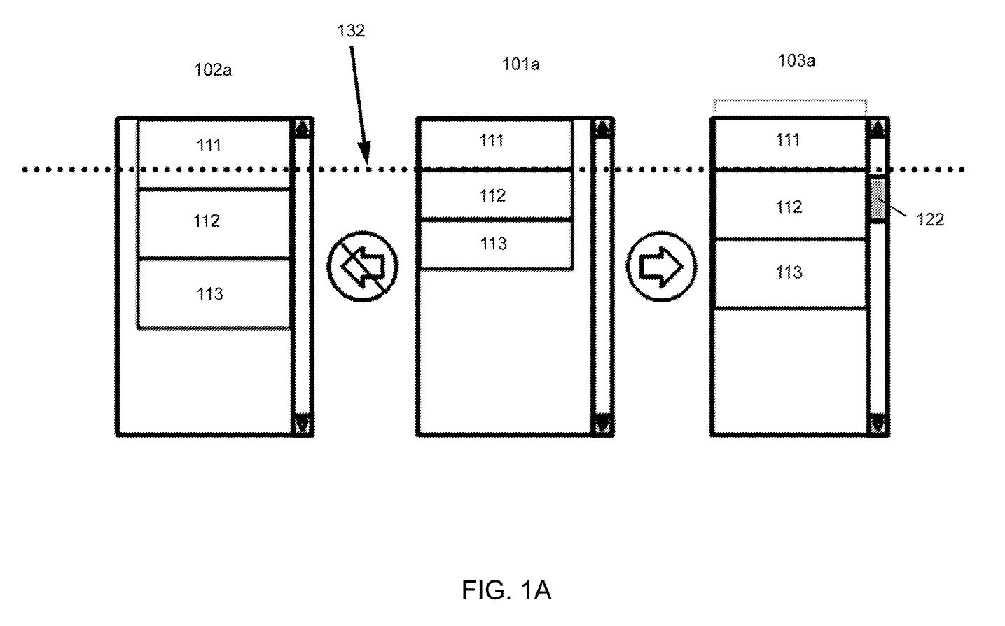

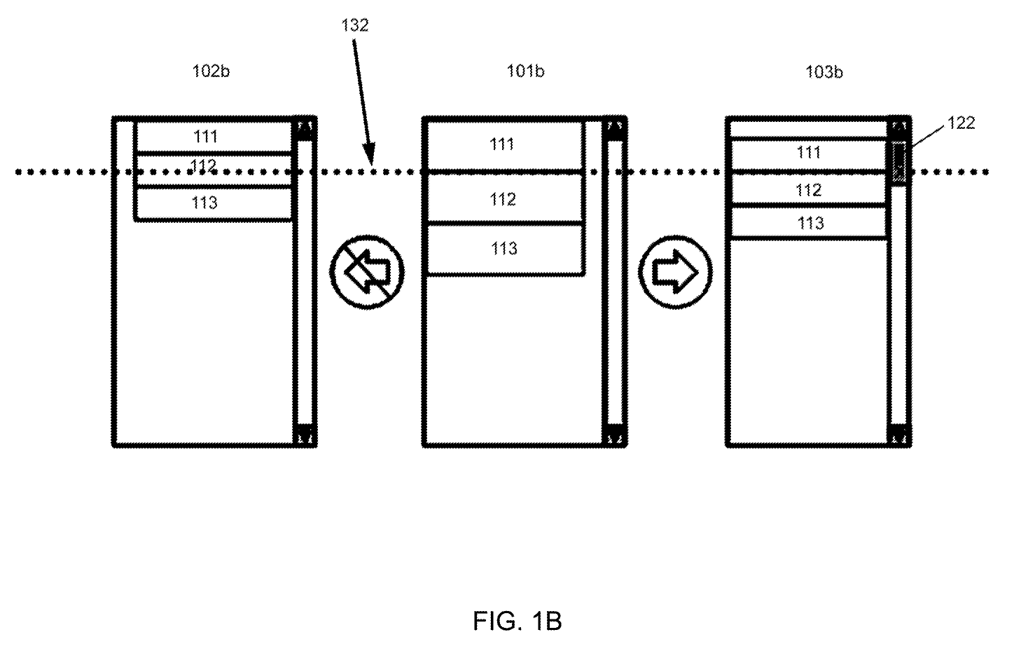

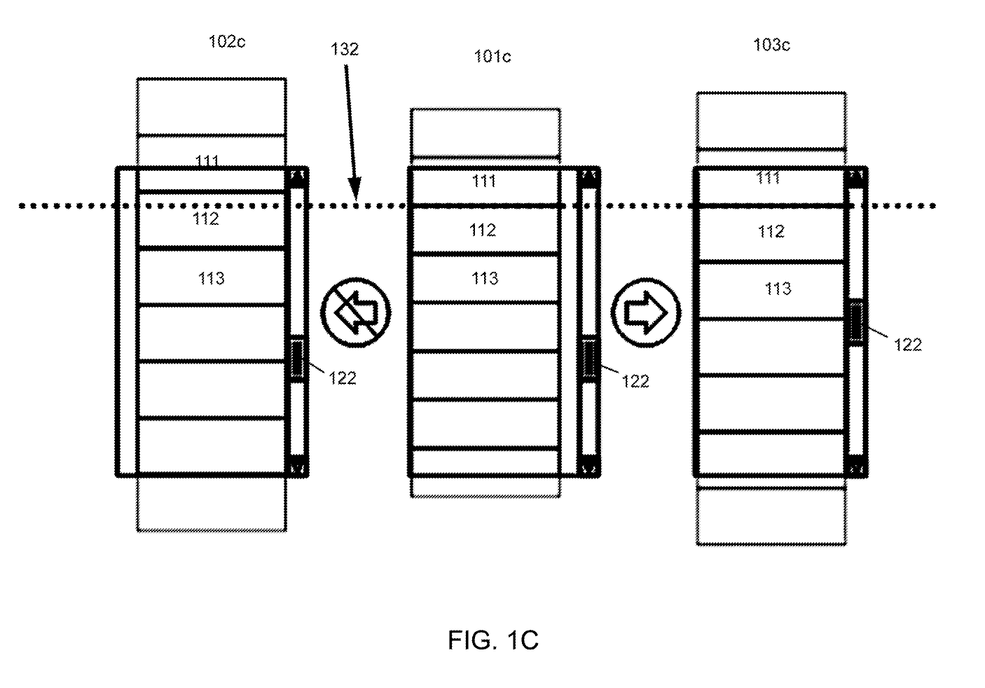

FIG. 1A shows a diagram of three screen views 102a, 101a, and 103a. The boxes on the screen, box 111, box 112, and box 113, represent the screen real-estate occupied by the three list items. Screen view 101a represents a beginning point for editing the list item 112. In the example of FIG. 1A, when editing item 112 of screen view 101a in such a way as it and the other boxes become more tall (e.g. a larger font size in all boxes). As can be seen in screen view 102a, according to the prior art conventions, the box 112 being presently edited would move down, or lower on the screen. According to the technique described herein as shown to the right in FIG. 1A by screen view 103a, by anchoring the position of the top of box 112 on the screen at location 132, the area being edited remains near the location 132 on the screen. To facilitate the substantially same on screen position of box 112, box 111 can be partially moved “off screen” as is indicated by the appearance of scroll bar 122.

### Example 2

FIG. 1B shows a diagram of three screen views 102b, 101b, and 103b. The boxes on the screen, box 111, box 112, and box 113, represent the screen real-estate occupied by the three list items. Screen view 101b represents a beginning point for editing the list item 112. In the example of FIG. 1B, when editing item 112 of screen view 101b in such a way as it and the other boxes become less tall (e.g. a smaller font size), as can be seen in screen view 102b, according to the prior art conventions, the box 112 being presently edited would move up, or higher on the screen. According to the technique described herein, and as shown to the right in FIG. 1B by screen view 103b, by anchoring the position of the top of box 112 at location 132, the area being edited remains near the location 132 on the screen. The appearance of scroll bar 122 shows the use of the scroll bar value to maintain the substantially unchanged position of the now less tall box 112 in screen view 103b.

### Example 3

FIG. 1C shows a diagram of three screen views 102c, 101c, and 103c. The boxes on the screen, box 111, box 112, and box 113, represent the screen real-estate occupied by the three list items. Screen view 101c represents a beginning point for editing the list item 112. In the example of FIG. 1C, there are already list items off of the visible screen, both above and below box 112 which is currently being edited. In the case of FIG. 1C, when editing item 112 of screen view 101c in such a way as it and the other items become more tall (e.g. a larger font size), as can be seen in screen view 102c, according to the prior art conventions, the box 112 being presently edited would move up, or higher on the screen. According to the technique described herein as shown to the right in FIG. 1C by screen view 103c, by anchoring the position of the top of box 112, the area being edited remains near the location 132 on the screen as the other list items move. In FIG. 1C, screen view 103c, those below and above box 112 and the scroll bar 122 move accordingly to accommodate the increased height of box 112.

In one embodiment, the process to accomplish the advantageous fixed position editing of FIG. 1, 103a, FIG. 1B, 103b, and FIG. 1C, 103c proceeds as follows: 1) On notice of a list change and detections of a user edit by the computer program (e.g. a user selection to change a font size), the current scroll bar position and the y coordinate of the top of the item (e.g. a box 112) being edited is recorded. A delta between that y coordinate and the scrollbar position which represents the y coordinate of the list content to be shown at the top of the list is also calculated. 2) The item size and position for all other items in the list is recalculated. 3) Based on the results of step 1 and step 2, the scroll bar value is reset to a value that will maintain the y coordinate of the top of the item (e.g. a box 112) being edited as recorded in step 1.

Note that in the examples of FIG. 1 and FIG. 1B, the boxes could still fit on one screen, yet in screen view 103a and screen view 103b, the scroll bar has been automatically invoked. It was realized that in such cases, invoking the scroll bar in this non-traditional way can be exploited to effect the substantially stationary position of the item represented by box 112 near location 132.

In one embodiment, a computer a position of a reference point of an item on the computer display a value of the scroll bar are recorded. Then, a new location of the reference point of the item and a new value of the scroll bar are calculated such that following a user edit, the reference point of the item remains at a substantially fixed position on said computer display.

Before describing the process in more detail, the scrollbar and scrollbar value is described. The scrollbar value represents a y coordinate that can range from nMin to nMax where the current value is nPos. Scrollbar value nPos is the y coordinate of the logical space to be drawn at the y coordinate 0 of the physical space, i.e. the top of the list.

### Example 4

A list of 5 items of height 10 summing up to 50 pixels are to be displayed in an area only 30 pixel in height. To display the item #1 at the top of the list, scrollbar value nPos is set to 0, because 0 is the top of that item in logical space. To cause item #2 to be displayed at the top of the list scrollbar value nPos is set it to 10, 20 for #3 and so on. For that reason, the minimum value you can set to the scrollbar is 0 and the maximum is 40, i.e. the top of the item #5. Thus, for the list of this example, nMin=0 and nMax=40.

However, where the items are big enough to fill the entire list (e.g. example 4), white space is generally not shown at the end of the list. To avoid white space shown at the end of the list, the nMax value can be adjusted by subtracting the list height from the last item bottom coordinate. In this example the last item bottom y coordinate is 50 and the list height is 30 so the maximum possible value to avoid white space shown at the end of the list, is 50-30, i.e. 20. In this case of no white space shown at the end of the list nMin=0 and nMax=20.

In some embodiments, the inventive process as described hereinbelow in more detail uses unconventional nMin and nMax values.

### Example 5

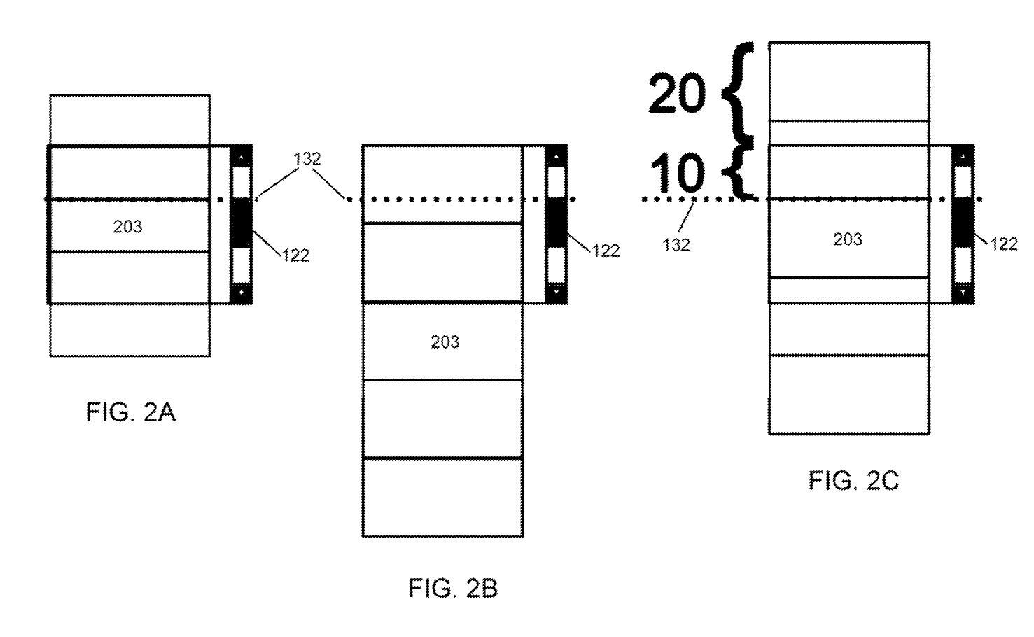

Building from example 4, as shown in FIG. 2A, a user is currently editing item 3 203 and the scrollbar values are nPos=10, nMin=0, nMax=20. A user edit is about to cause an increase of the item height from 10 to 15. That is, item 3 203 is about to become larger in the height direction by 5 (e.g. five pixels). The top of item 3 203 is initially at 10 in physical space before the user edit. Since the user is presently editing item 3 203, in the exemplary steps which follow, we want to preserve this on screen position of the top of item 3 203 (as opposed to preserving the on screen position of the top of the list as is typically done in the prior art). Step 1: Store the current y coordinate of the item of interest in a variable nCurrentYValue. nCurrentYValue=10 in this example. Step 2: Recalculate, the position of all the items in the list in logical space. Before the next steps, we now reset nPos to 0 for illustration purposes. FIG. 2B shows the displayed list following step 2. Step 3: The new logical top of the same item is calculated and stored in nNewYValue. In this example nNewYValue=30. Step 4: The goal is to maintain the current item's top at the nCurrentYValue. This means that nNewYValue−nPos=nCurentYValue. nPos is re-calculated and we know the other 2 variables. The equation to calculate nPos is nPos=nNewYValue−nCurrentYValue. In our example nPos=(30−10)=20. As shown in FIG. 2C, the goal being to have item 3 displayed at position 10, we calculate the difference between nNewYValue and nCurrentYValue, here, 30−10=20. Step 5: At this point, we have the right nPos value but nMin and nMax have yet to be calculated. Here nMin is 0 and nMax is (15×5)−30=45. If nPos falls between these normal nMin and nMax value, the process is complete. But we have to deal with a few edge cases.

If nPos is positive but greater than nMax, there is a Step 6A: Set nMax to be nPos. This will allow for whitespace at the bottom of the list, such as, for example, when the items following the active item are shrinking (becoming shorter in height). If however nPos is negative i.e. less than 0, there is a Step 6B: Set nMin to nPos. This will allow for whitespace at the top of the list, such as, for example, when the items preceding the active item are growing (becoming taller in height).

Items on a Page Remain Stationary:

While the techniques described herein were conceived to solve the problem of moving items of a list during editing, it is contemplated that such techniques can be more generally applied to cause items on a page to remain substantially stationary, such as, for example, during text entry and or editing.

### Example 6

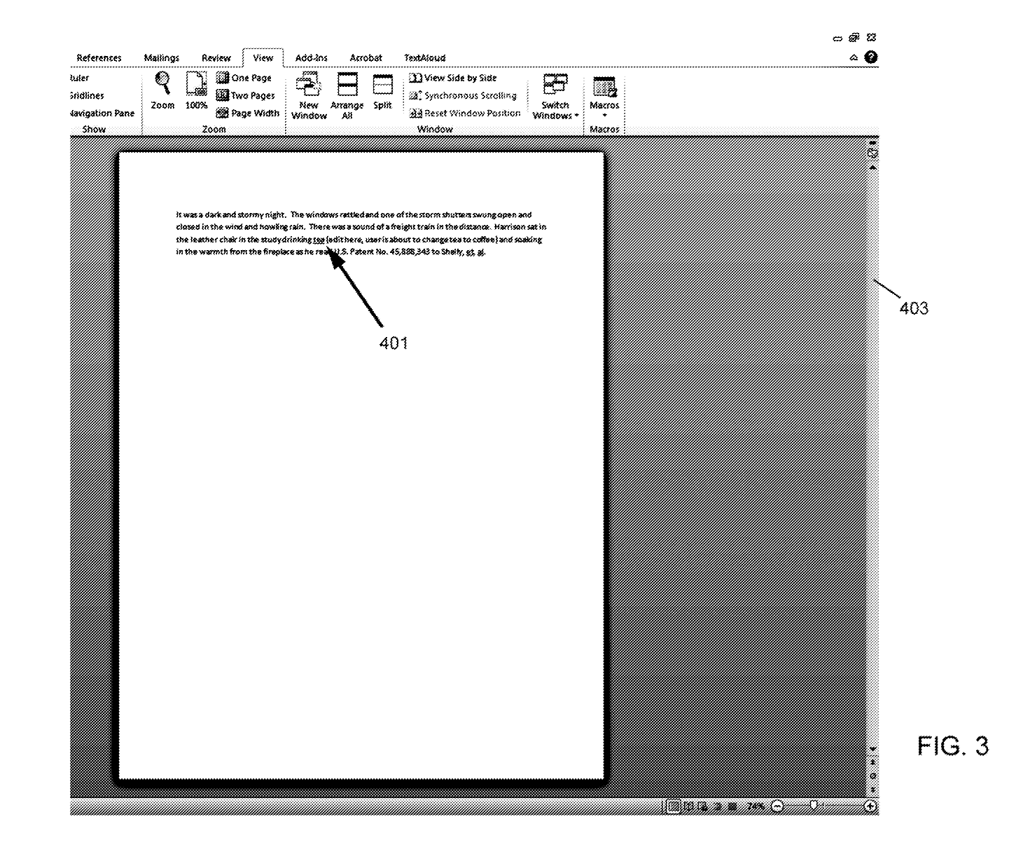

FIG. 3 shows a Word™ document written in a Calibri 11 font. The entire text being edited fits within the upper portion of the one page computer display screen. The user is presently editing at a location 401 near the word “tea”, as is shown underlined in FIG. 3. In FIG. 3, one page is displayed and the text fits in the one page. Thus, there is no visible scroll bar in the scroll bar track 403.

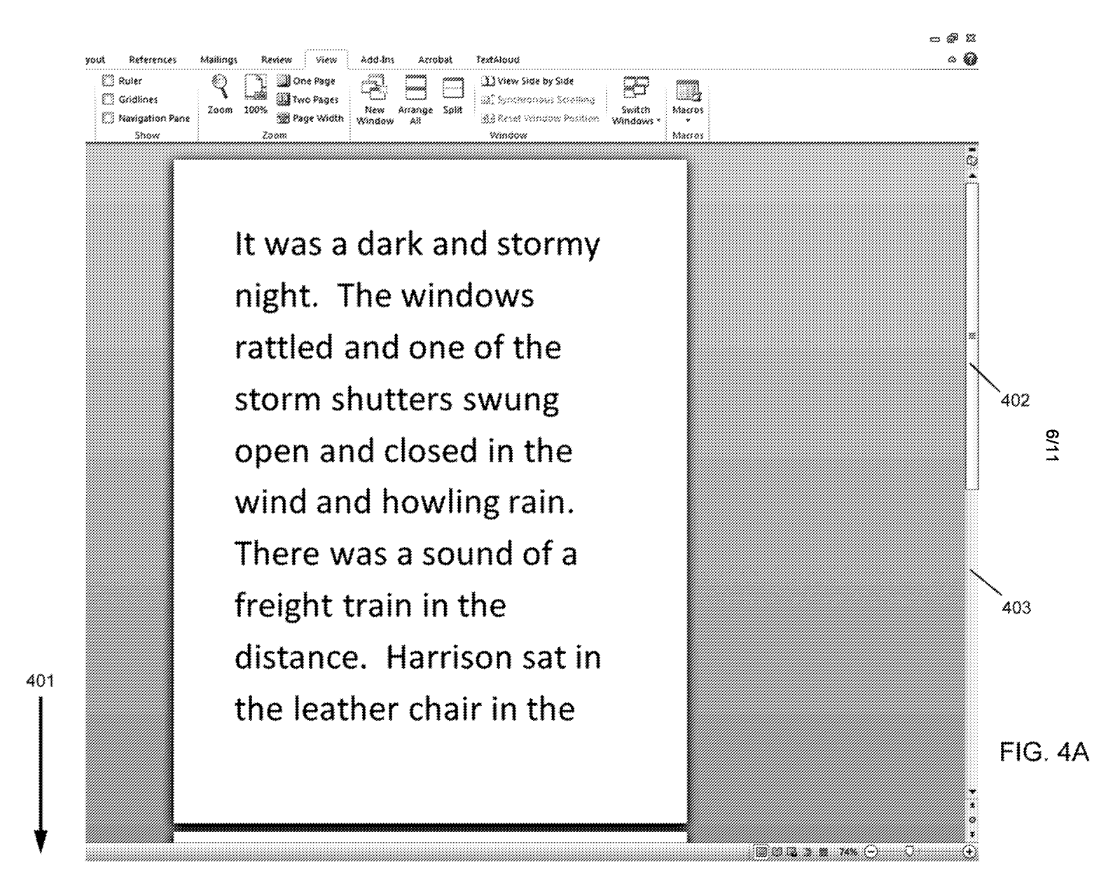

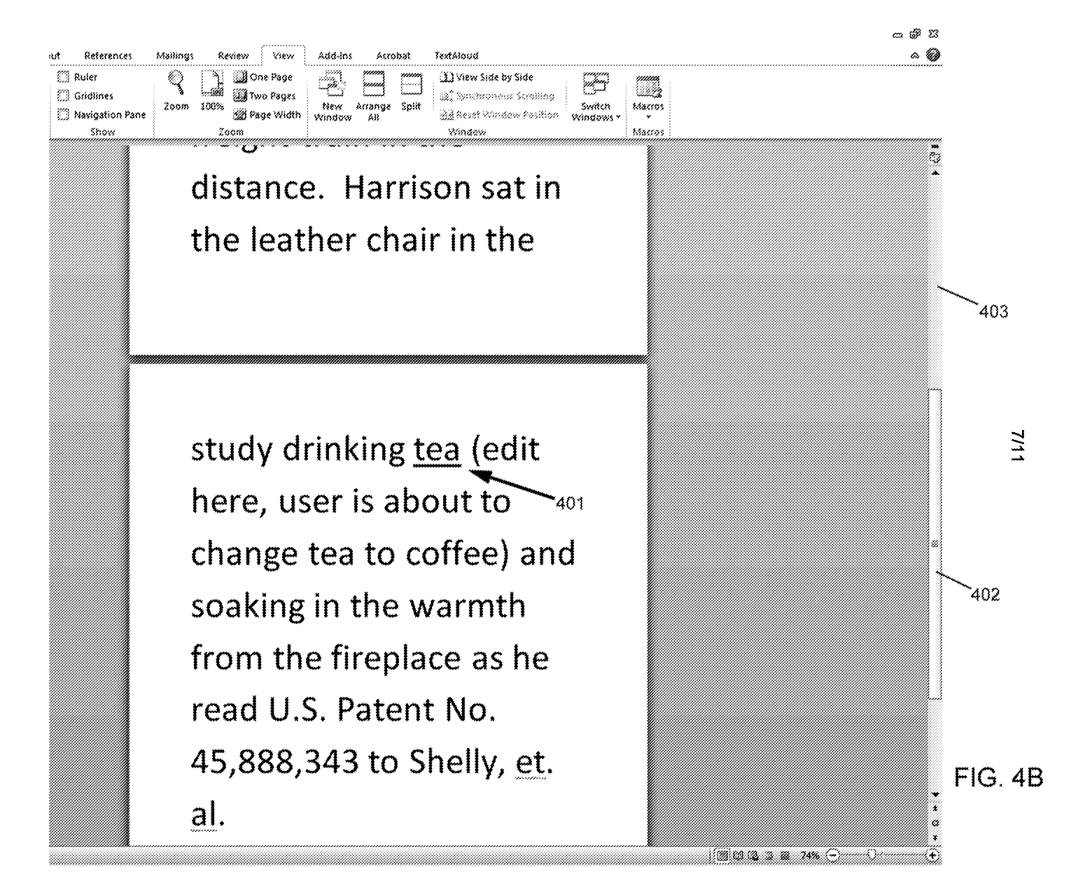

As shown in FIG. 4A and FIG. 4B, the user first changes the font size to a Calibri 44 font before continuing user editing at the word “tea”. As can be seen in FIG. 4B, according to the conventional cursor entry point control of the prior art, by selecting a new font size for the entire page or entire document, such as can be accomplished, for example, by ctrl-a followed by the font size selection, the point of editing has moved to page 2 and the cursor entry point has been momentarily lost to another page (here, a second presently off-screen page, as shown by FIG. 4B). The text now fills more than one screen view and scroll bar 402 appears in the scroll bar track 403. As indicated by the arrow 401 in the lower left of FIG. 4A, editing location 401 has moved off the visible screen.

The user has to first navigate back to the desired cursor entry point location 401 by first scrolling down to the correct page as shown in FIG. 4B, then mouse click at the original cursor entry point location 401 (e.g. near the word tea in FIG. 4B) to continued editing.

It is contemplated that a better technique would be to first store the present position of the cursor (e.g. the y or x-y coordinates), store the scroll position, allow the user to adjust some property or style of the document, then automatically and transparent to the user, calculate by computer new y or x-y coordinates and a new scroll bar position that corresponds to the original cursor entry point (i.e. near the word “tea”). In this exemplary word processing document, since it is understood that particular words move left and right according to font size and paragraph style, it is understood that the cursor can maintain a meaningful y coordinate while moving right or left along the x direction to reappear near a word that was originally being editing (i.e. near a location of the cursor entry point, before the font size was changed).

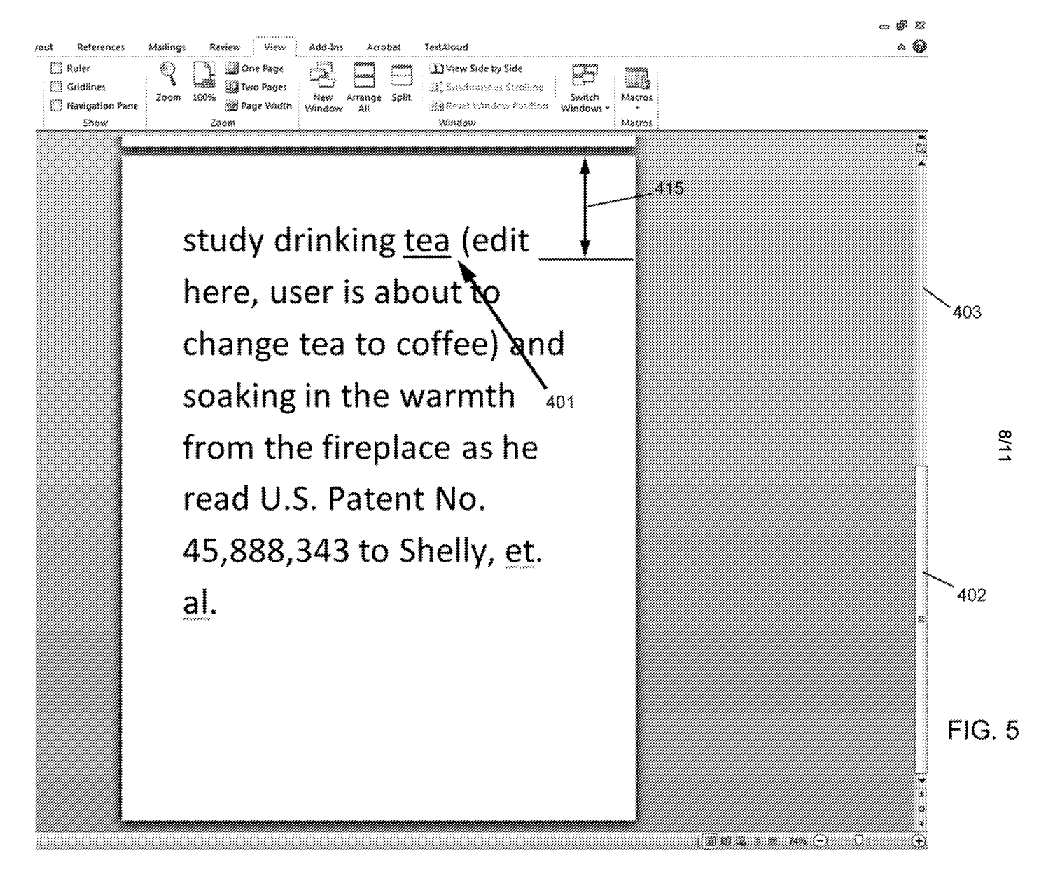

FIG. 5 shows how a location 401 can be maintained near the original cursor entry point location 401 using the techniques described hereinabove. Notice that according to the inventive process, scroll bar 402 moves down automatically by computer in scroll bar 403 to place location 401 at the about the same location on the display screen as where the user was editing immediately before the font change from a Calibri 11 font of FIG. 3, to the Calibri 44 font of FIG. 5. It is believed that by so maintaining a cursor entry point, such as location 401 near an item being edited in FIG. 5, that user fatigue and user distraction can be minimized. Thus, the need to find and navigate back to location 401 as shown in FIG. 4A and FIG. 4B can be minimized or in some cases, completely eliminated. The exact dimensions, e.g. line number and/or right-left screen position associated with the phrase “near the original cursor entry point” (e.g. location 401) using the techniques described hereinabove can vary by application and/or by the magnitude of the object size change. For example, in some relatively high resolution applications, near can mean within some tens of pixels of the original cursor location. In other applications, such as, for example, the example of a word processing change of font size from a Calibri 11 font of FIG. 3, to the Calibri 44 font of FIG. 5, near can mean on about the same line number and near the character or word where the original editing was being done, as redrawn and re-rendered in the new font size (i.e. a distance 415 below the top edge of the page).

It is believed that the techniques described hereinabove are particularly suitable for use in any text editing computer application that involves the display of characters of text where the position on a display screen and/or the position of the display scroll bar can be made to move automatically as a function text properties, such as, for example, font size.

While the example of FIG. 3, FIG. 4A, FIG. 4B, and FIG. 5, described the process as applied to a word processing document, it is believed that the process can be used to maintain a cursor entry point in any type of computer program that makes use of a cursor entry point on a computer display screen, where following some operation that generally would otherwise move the cursor entry point on a redrawn screen away from an item presently being edited. The same process as described hereinabove can be applied, so that following any changes that cause the screen to be redrawn, the cursor entry point remains redrawn or re-rendered at about the same screen position as it was before the screen was re-drawn. Moreover, the cursor entry point position can be adjusted in either a x direction or adjusted in both the x direction and in the y direction so as to remain in close proximity to an item that was being edited before the screen was redrawn (e.g. following re-scaling of an object in the drawing).

It will be understood by those skilled in the art that the processes as described can be applied in any suitable context where the area or point on a display that the user is currently looking at could be moved as a result of the user's action or another process, such as, for example, another computer process. For example, the user might be looking at a picture in a list of pictures that is dynamically updated by a computer background process. The list can be automatically updated using the processes described herein so that the object of user focus (e.g. as indicated by present user editing) before the computer process executed, remains in substantially the same location on a computer display after the computer background process has run.

In the text editing example 6, the y coordinate (up-down display direction) was maintained about at the same line number and the x coordinate (right-left display direction) was allowed to float to a character or word near an original editing position. However, in other applications (e.g. applications beyond text entry), there can be preservation of both the x and y coordinates, where following an edit, a point of user visual focus can be maintained substantially in the same place before and after an object is edited. It is contemplated that the same concept can be applied to any dimension in a multi-dimensional space as can be represented on a viewable display. The same process as described hereinabove is believed applicable to either a 2D screen or 3D renderings of 3D objects, before and after an edit of a 3D object by maintaining the x, y, and z coordinates in substantially the same position on the display. The processes are believed to be applicable to both 2D display screens as well as to any suitable 3D display technologies, for example including holographic 3D displays and other types of laser based 3D display technologies.

The processes described herein are also believed applicable to applications that include a non-visual dimension, such as, for example, time, as another dimension which can be represented on a display, such as a by a time line. That is, for example, x and time or x and y and time, or x and y and z and time, can be maintained in substantially the same position on a display before and after an object has moved in time as the result of the edit. It is contemplated that other non-visual dimensions beyond time which can be mapped to a computer display can similarly be made substantially static across a user edit.

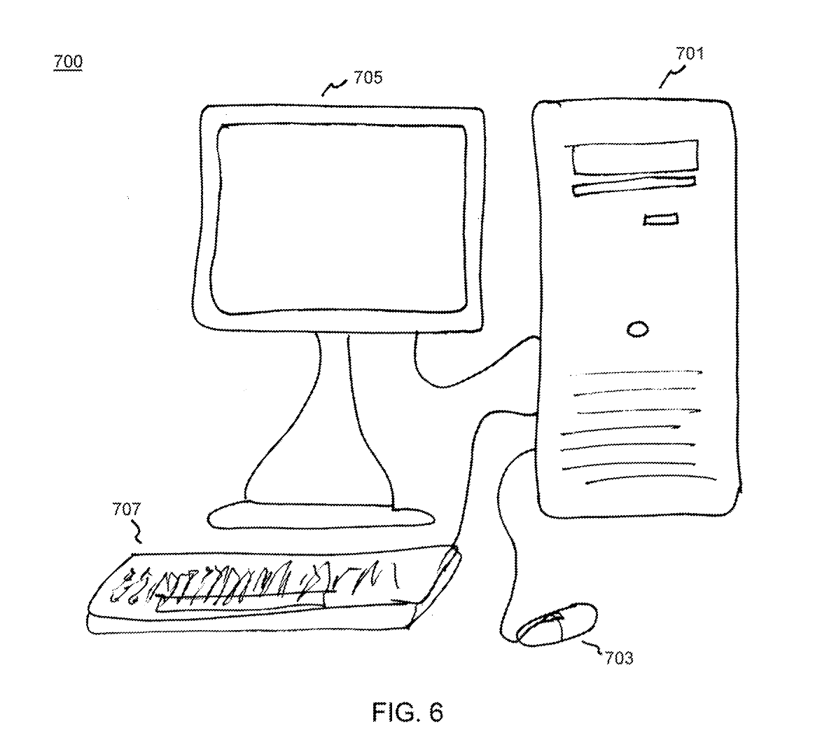

FIG. 6 shows a block diagram of a computer system 700 suitable to perform the processes as described herein. Computer 701 has associated with it a user input device 703, such as for example a computer mouse, keyboard 707, and a computer display 705. The computer readable code configured to run on a computer 701 can reside on any suitable computer readable non-transitory storage medium such as for example a CD, DVD, hard drive, solid state drive, etc. (not shown in FIG. 1C). A computer suitable to perform the processes described hereinabove can include any suitable type of computer, such as for example, a personal computer having any suitable operating system. It is further contemplated that the inventive processes as described herein can be practiced on any suitable computer based device having a computer processor or firmware which simulates the functions of a computer processor.

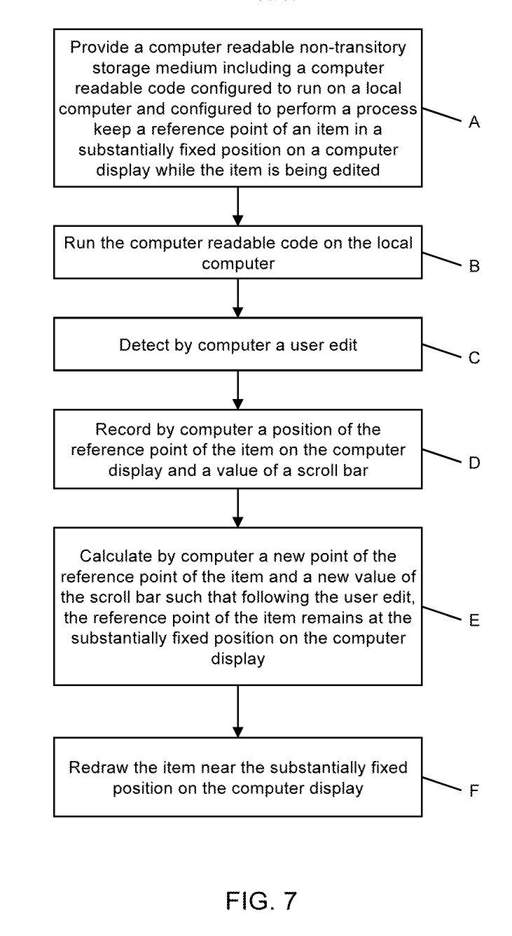

FIG. 7 shows a block diagram of one exemplary process for ergonomic display of objects after the size of an object is changed. The steps include: 1) Provide a computer readable non-transitory storage medium including a computer readable code configured to run on a local computer and configured to perform a process keep a reference point of an item in a substantially fixed position on a computer display while the item is being edited; 2) Run the computer readable code on the local computer; 3) Detect by computer a user edit; 4) Record by computer a position of a reference point of the item on the computer display and a value of a scroll bar; 5) Calculate by computer a new point of the reference point of the item and a new value of the scroll bar such that following the user edit, the reference of the item remains at the substantially fixed position on the computer display; and 6) Redraw the item near the substantially fixed position on the computer display.

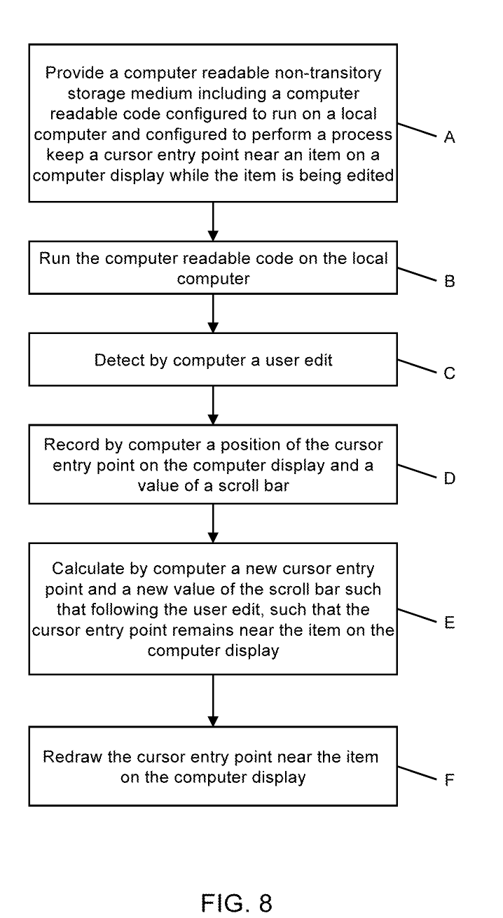

FIG. 8 shows a block diagram of one exemplary process for ergonomic display of a cursor after the size of an object is changed. The steps include: 1) Provide a computer readable non-transitory storage medium including a computer readable code configured to run on a local computer and configured to perform a process keep a cursor entry point near an item on a computer display while the item is being edited; 2) Run the computer readable code on the local computer; 3) Detect by computer a user edit; 4) Record by computer a position of the cursor entry point on the computer display and a value of a scroll bar; 5) Calculate by computer a new cursor entry point and a new value of the scroll bar such that following the user edit, such that the cursor entry point remains near the item on the computer display; and 6) Redraw the cursor entry point near the item on the computer display.

While the present invention has been particularly shown and described with reference to the preferred mode as illustrated in the drawing, it will be understood by one skilled in the art that various changes in detail may be affected therein without departing from the spirit and scope of the invention as defined by the claims.

What is claimed is:

1. A method comprising the steps of:
providing a computer readable non-transitory storage medium comprising a computer readable code configured to run on a local computer and configured to perform a process to keep a reference point of an item in a substantially fixed position on a computer display while said item is being edited;
running said computer readable code on said local computer;
detecting by computer a user edit;
recording by computer a position of said reference point of said item on said computer display and a value of a scroll bar;
calculating by computer a new point of said reference point of said item and a new value of said scroll bar such that following said user edit said reference point of said item remains at said substantially fixed position on said computer display; and
redrawing said item near said substantially fixed position on said computer display.

2. The method of claim 1, wherein said user edit comprises an edit of a property of one or more characters of text.

3. The method of claim 2, wherein said property comprises a font size.

4. The method of claim 2, wherein said property comprises a font type.

5. The method of claim 1, wherein said user edit comprises an edit of a graphic object.

6. The method of claim 1, wherein said item is an item of a list of items and wherein said user edit comprises a user edit of said list of items.

7. The method of claim 6, wherein said step of calculating by computer a new point of said reference point comprises said item edited for increased height on said computer display and said scroll bar causing an item above said item to move at least in part off of a presently displayed redrawn view.

8. The method of claim 6, wherein said step of calculating by computer a new point of said reference point comprises said item edited for decreased height on said computer display and said scroll bar causing at least one item above said item and at least one item below said item to move closer to said item.

9. The method of claim 1, wherein said step of calculating by computer a new point of said reference point comprises calculating a new point in two or more dimensions.

10. The method of claim 1, wherein said step of calculating by computer a new point of said reference point comprises calculating a new point in a time dimension.

11. The method of claim 1, wherein said computer display comprises a 2D display screen or a 3D display system.

12. A method comprising the steps of:
providing a computer readable non-transitory storage medium comprising a computer readable code configured to run on a local computer and configured to perform a process to keep a cursor entry point near an item on a computer display while said item is being edited;
running said computer readable code on said local computer;
detecting by computer a user edit;
recording by computer a position of said cursor entry point on said computer display and a value of a scroll bar;
calculating by computer a new cursor entry point and a new value of said scroll bar such that following said user edit such that said cursor entry point remains near said item on said computer display; and
redrawing said cursor entry point near said item on said computer display.

13. The method of claim 12, wherein said computer readable code further comprises a word processing program and said item comprises a character of text.

14. The method of claim 13, wherein said user edit comprises a change of one or more characters of text.

15. The method of claim 14, wherein said change comprises a change of font size.

16. The method of claim 14, wherein said change comprises a change of font type.

17. A system comprising: a computer readable code configured to run on a local computer comprising a user entry device and a core program configured to perform a process to keep a reference point of an item in a substantially fixed position on a computer display while said item is being edited, said core program configured to run said computer readable code on said local computer; detect by computer a user edit; record by computer a position of said reference point of said item on said computer display and a value of a scroll bar; calculate by computer a new point of said reference point of said item and a new value of said scroll bar such that following said user edit said reference of said item remains at said substantially fixed position on said computer display; and to redraw said item near said substantially fixed position on said computer display.

18. The system of claim 17, wherein said core program comprises a computer graphics program and said item comprises an item of a list of items.

19. The system of claim 17, wherein said core program comprises a word processing program and said item comprises a character or a word.

20. The system of claim 17, wherein said user entry device comprises a computer mouse.
